(19) United States
(12) Patent Application Publication
(10) Pub. No.: US 2014/0244355 A1
(43) Pub. Date: Aug. 28, 2014

(54) Smart Analytics for Forecasting Parts Returns for Reutilization

(71) Applicant: INTERNATIONAL BUSINESS MACHINES CORPORATION, Armonk, NY (US)

(72) Inventors: Jeffrey M. Boniello, Poughkeepsie, NY (US); Michael B. Hay, Montpellier (FR); Vincent E. La Fera, Olivebridge, NY (US); Pitipong Jun Sen Lin, Brookline, MA (US); Kevin P. O'Connor, Hyde Park, NY (US); Borbala Palya, Vac (HU); John G. Parks, San Jose, CA (US); Jacob Thankamony, Chennai (IN)

(73) Assignee: INTERNATIONAL BUSINESS MACHINES CORPORATION, Armonk, NY (US)

(21) Appl. No.: 13/778,336

(22) Filed: Feb. 27, 2013

(51) Int. Cl. G06Q 10/04

(52) U.S. Cl. CPC G06Q 10/04
USPC 705/7.31

(57) ABSTRACT

An approach is provided in which the approach maps first parts included in a first system to second parts included in a second system. The approach then utilizes functioning first parts returns data, which indicates an amount of parts included in the first system that have been returned and are functioning, to forecast an amount of functioning parts corresponding to the second system to be returned. As such, the approach generates a functioning second parts returns forecast based upon the amount of functioning second parts that are forecast to be returned.

### BACKGROUND

The present disclosure relates to smart analytics for forecasting parts returns for reutilization. More particularly, the present disclosure analyzes production history and functioning parts returns history of a legacy system to forecast functioning parts returns of a next generation system.

Manufacturers receive functioning parts returns from customers that own systems for various reasons. One reason that customers return functioning parts is because they may wish to upgrade their systems for performance reasons, such as increasing memory and/or increasing processor performance. As a result, manufacturers obtain functioning parts that may be re-utilized for work orders such as warranty repairs. This is not only good for the environment, but it also contributes to a manufacturer's profit margins.

Normal procurement practice, however, requires a manufacturer to order new parts several months ahead of the manufacturer's planned utilization date. Longer lead-time parts require the manufacturer to order new parts even further in advance of the manufacturer's planned utilization date. As such, the manufacturer builds inventory of the purchased new parts and the functioning returned parts.

### BRIEF SUMMARY

According to one embodiment of the present disclosure, an approach is provided in which the approach maps first parts included in a first system to second parts included in a second system. The approach then utilizes functioning first parts returns data, which indicates an amount of parts included in the first system that have been returned and are functioning, to forecast an amount of functioning parts corresponding to the second system to be returned. As such, the approach generates a functioning second parts returns forecast based upon the amount of functioning second parts that are forecast to be returned.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a diagram showing an analytical forecaster generating a functioning parts returns forecast for a next generation system based upon functioning parts returns data corresponding to a legacy system;

FIG. 2 is a high level flowchart showing steps taken in generating a functioning parts returns forecast for a second system based upon a first system's production data and functioning parts returns data corresponding to the first system;

FIG. 3 is a flowchart showing steps taken in creating part groups and corresponding part categories within the part groups;

FIG. 4 is a flowchart showing steps taken in mapping parts utilized in a second system to parts utilized in a first system;

FIG. 5 is a flowchart showing steps taken in generating a functioning parts returns forecast and a new parts order plan for a second system's production lifecycle;

FIG. 6 is a diagram showing two system production curves and two corresponding functioning parts returns curves;

FIG. 7 is a diagram showing a first parts return curve segmented and analyzed in three sections;

FIG. 8 is a diagram showing first system parts mapped to second system parts according to a part group and part category;

FIG. 9 is a block diagram of a data processing system in which the methods described herein can be implemented; and

FIG. 10 provides an extension of the information handling system environment shown in FIG. 9 to illustrate that the methods described herein can be performed on a wide variety of information handling systems which operate in a networked environment.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The following detailed description will generally follow the summary of the disclosure, as set forth above, further explaining and expanding the definitions of the various aspects and embodiments of the disclosure as necessary.

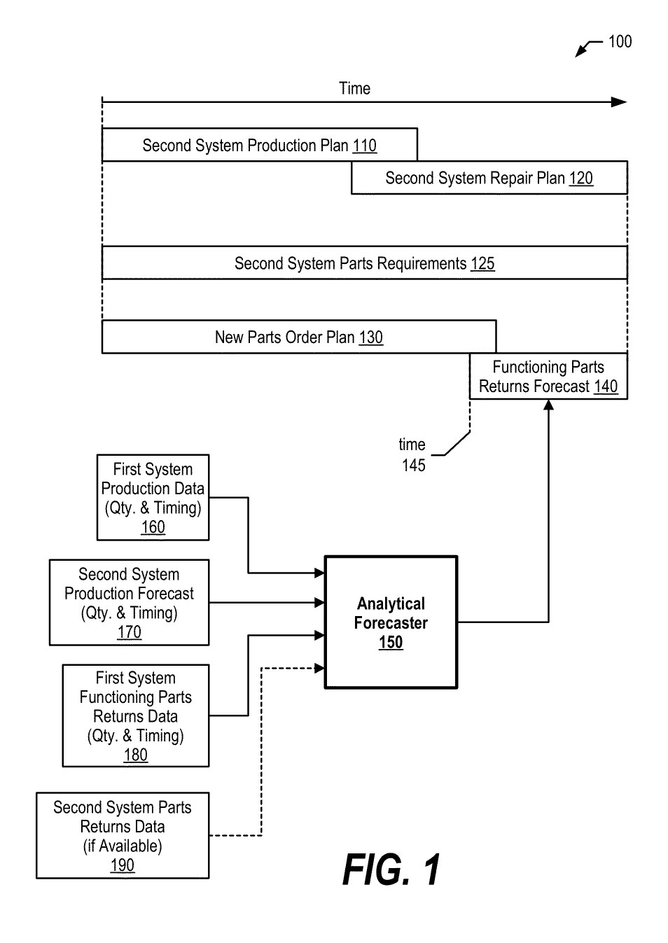

FIG. 1 is a diagram showing an analytical forecaster generating a functioning parts returns forecast for a next generation system based upon functioning parts returns data corresponding to a legacy system. Analytical forecaster 150 analyzes production data 160 and parts returns data 180 from a legacy system (referred to herein as a first system) and extrapolates the analysis onto a next generation system (referred to herein as a second system) production and repair lifecycle (110 and 120). Based on the extrapolation, analytical forecaster 150 accurately forecasts the quantity and timing of returned functioning parts (functioning parts returns forecast 140) of the next generation system, which may be utilized for work orders such as warranty repairs. As a result, a scheduler reduces the amount of new parts to order (new parts order plan 130) to fulfill the lifecycle parts requirements of the next generation system.

Different system versions may utilizes different part versions, which may have different return life cycles. For example, the returns pattern for a 4 GB memory (base version) might be earlier and more consistent than the returns pattern for a 16 GB memory (premium version). As such, this disclosure correlates part versions between a first system and a second system based upon part grouping (e.g., processor, memory) and categories within the group (base version, premium version, etc.)

FIG. 1 shows timeline graph 100, which includes second system production plan 110 and second system repair plan 120 (e.g., next generation systems). Second system repair plan 120 may include, for example, estimated warranty repairs on systems that will be built during second system production plan. Second system parts requirements 125 include parts requirements to fulfill second system production plan 110 and second system repair plan 120. As those skilled in the art can appreciate, second system parts requirements 125 may include hundreds of different part types and quantities.

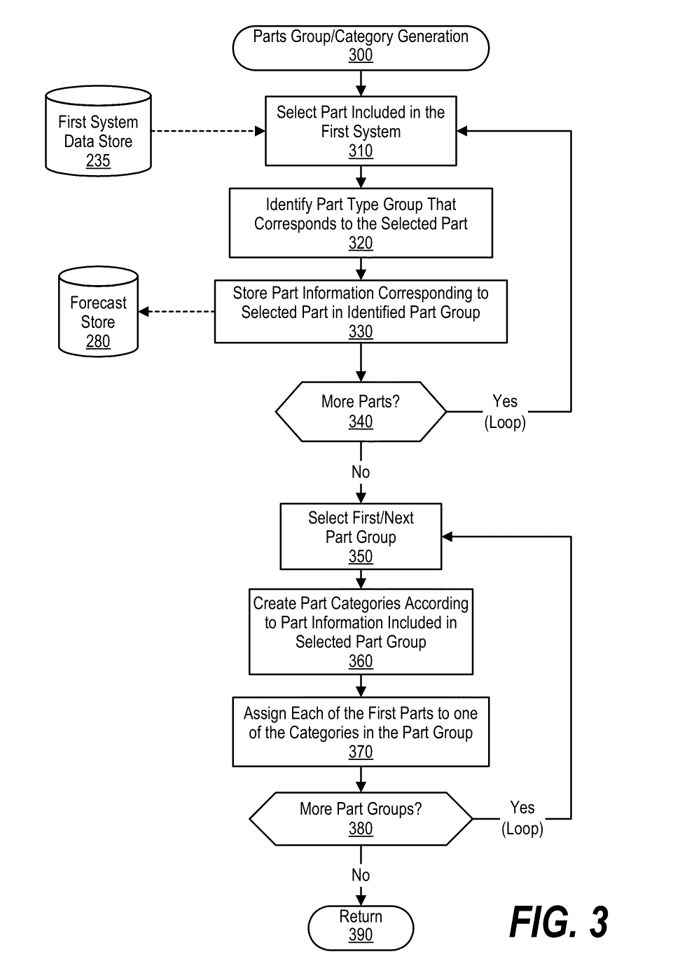

In order to accurately generation functioning parts returns forecast 140, analytical forecaster 150 retrieves first system production data 160 and second system production forecast 170 that, in one embodiment, includes production rates (quantity and timing) and part information corresponding to a first system type (legacy system) and a second system (next generation system), respectively. Analytical forecaster 150 uses this system information to correlate parts between the first system and the second system. For example, premium processors used on a first system are correlated with premium processors on the second system (see FIGS. 3-4, 8, and corresponding text for further details).

In one embodiment, part correlation is performed on a “relative” basis to a system. For example, a legacy system may have shipped a 16 GB memory device as a premium memory, whereas a next generation system may plan to ship a 16 GB memory device as a mid-level version due to technological advancements.

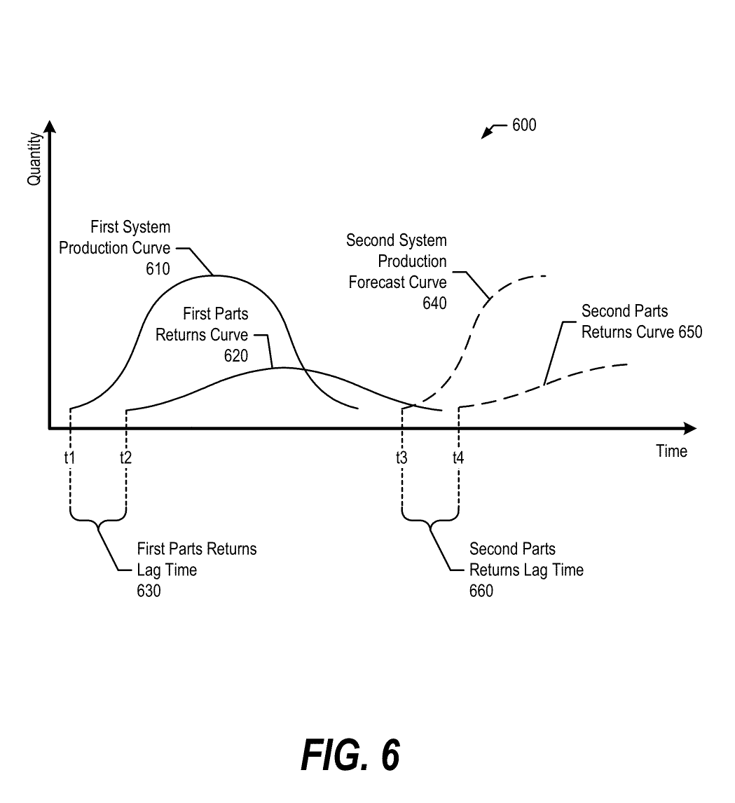

Analytical forecaster 150 retrieves functioning first parts returns data 180 that identifies parts included in a first system's production build that were returned and functioning (e.g., customer upgrades). In turn, analytical forecaster 150 uses first system functioning parts returns data 180 along with information gathered from analyzing first system product data 160 and second system product forecast 170 to generate functioning parts returns forecast 140. Functioning parts returns forecast 140 includes a forecast of parts utilized in the second system that will be returned and still functional. In one embodiment, functioning parts returns forecast 140 includes a start time at which to expect returned parts (time 145, see FIG. 6 and corresponding text for further details). As those skilled in the art can appreciate, time 145 may occur prior to the end of second system production plan 110.

As such, a scheduler can plan when to use functioning returned parts to fulfill a portion of second system parts requirements 125 and reduce the amount of new parts to place on order (new parts order plan 130).

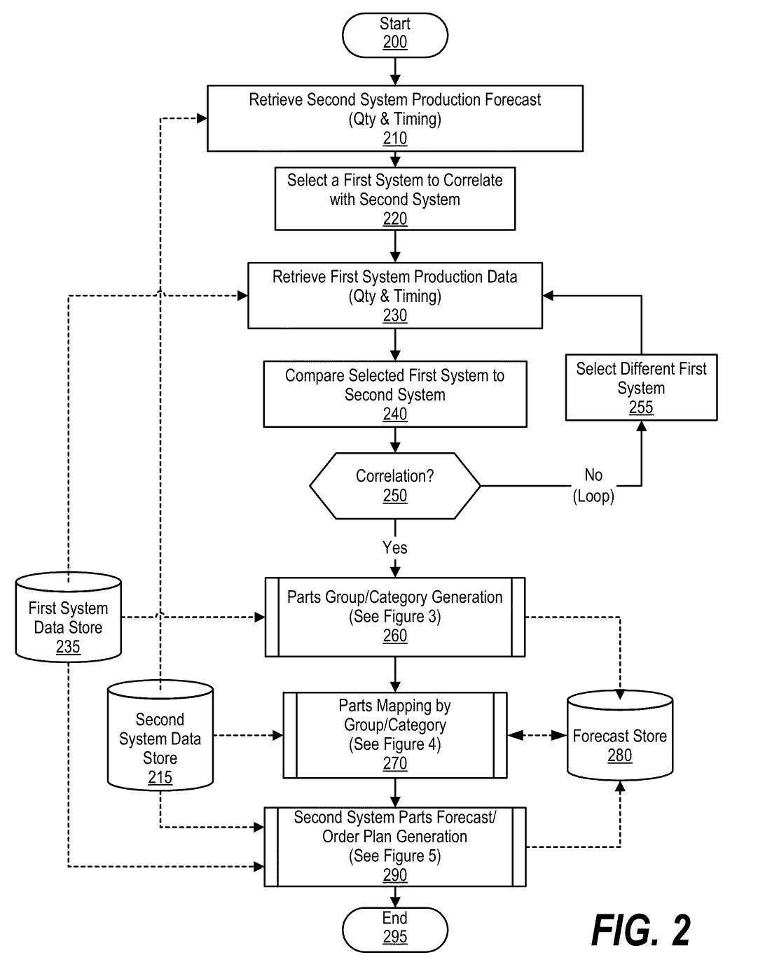

FIG. 2 is a high level flowchart showing steps taken in generating a functioning parts returns forecast for a second system based upon a first system's production data and functioning parts returns data corresponding to the first system. Processing commences at 200, whereupon processing retrieves a second system production forecast from second system data store 215. In one embodiment, the production forecast includes the amount of second systems (broken out by version) planned to be built over time.

At step 220, processing selects a first system to correlate with the second system, such as a from a predecessor product line. For example, a business may have six server products from a legacy product line and processing selects one of the six servers. At step 230, processing retrieves system data corresponding to the selected first system from first system data store 235. At step 240, processing compares the second system production forecast to the selected first system's production data, such as by comparing actual sales/returns of first systems to forecasted sales/returns of the second system.

A determination is made as to whether correlation exists between the selected first system and the second system (e.g., via pairwise or rank) (decision 250). If correlation does not exist, decision 250 branches to the “No” branch, whereupon processing loops back to select a different first system at step 255 (e.g., a different server version from the product line). This looping continues until a first system is identified that correlates with the second system, at which point decision 250 branches to the “Yes” branch.

Processing creates part groups (e.g., processors, memory, etc.) and part categories within the part groups (e.g., premium, mid-level, base, etc.) using part information corresponding to the first system (pre-defined process block 260, see FIG. 3 and corresponding text for further details). As those skilled in the art can appreciate, other mechanisms may be used to create the part groups/categories, such as by using parts included in the second system or creating pre-defined part groups and/or part categories.

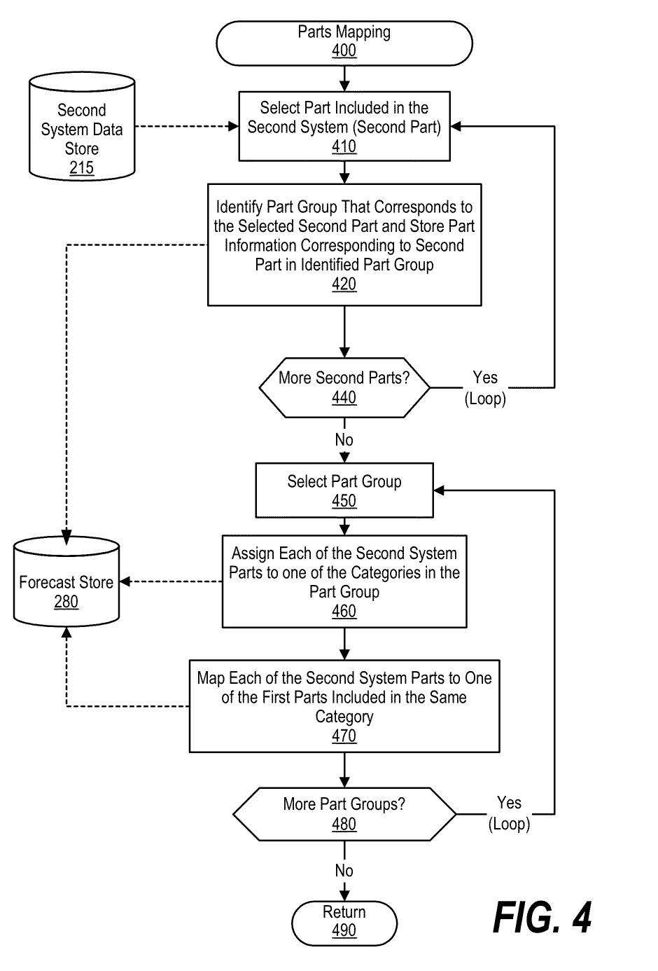

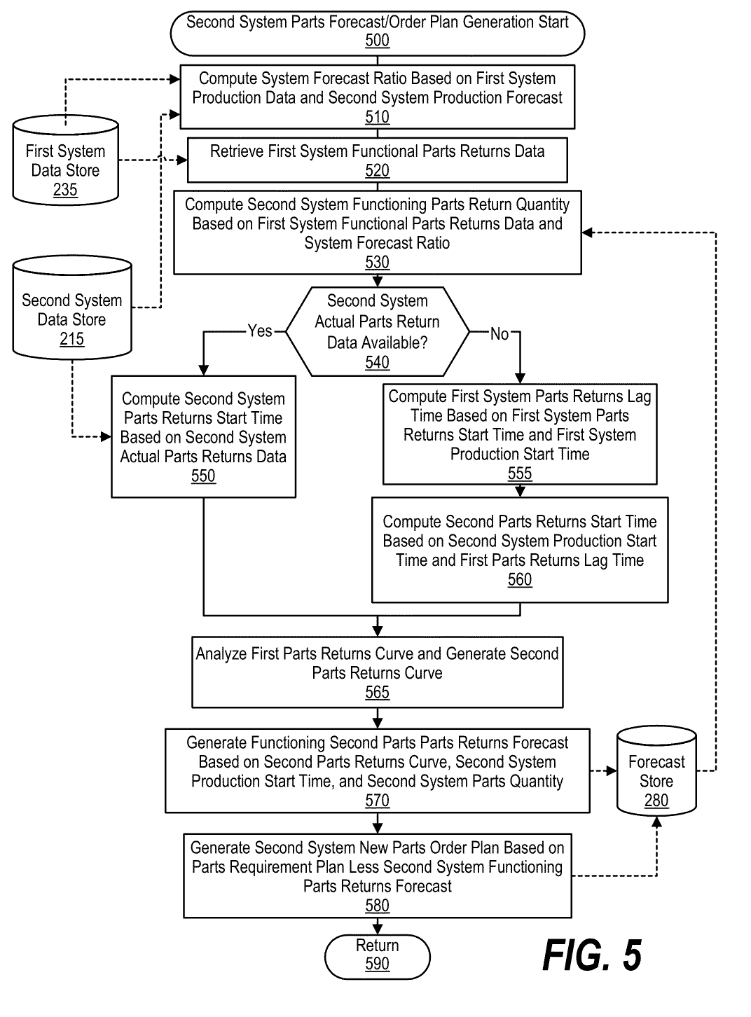

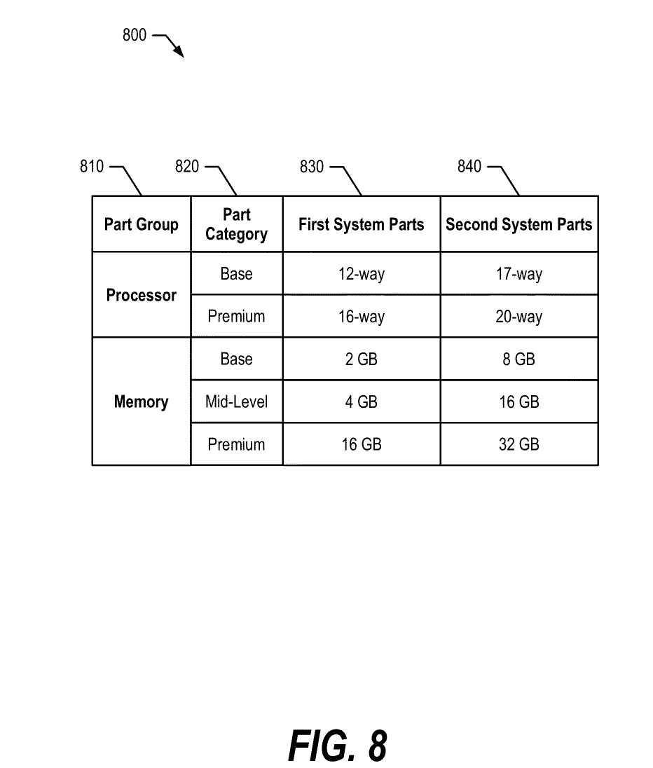

In turn, processing maps parts utilized in the second system to parts utilized in the first system (pre-defined process block 270, see FIG. 4 and corresponding text for further details). In one embodiment, the mapping information is stored in forecast store 280 as table entries (see FIG. 8 and corresponding text for further details). Processing utilizes the mapping information, along with other factors, to generate, for each part, an individual functioning parts returns forecast and a corresponding new parts order plan (pre-defined process block 290, see FIG. 5 and corresponding text for further details). Processing ends at 295.

FIG. 3 is a flowchart showing steps taken in creating part groups and corresponding part categories within the part groups. Processing commences at 300, whereupon processing selects a part utilized in a first system at step 310. In one embodiment, processing retrieves part information from first system data store 235 that includes a part number and performance information.

Processing, at step 320, identifies a part group corresponding to the selected part (e.g., processor, memory, etc.) and stores part information (e.g., part number) in the identified part group, such as in a table entry located in forecast store 280 (step 330). A determination is made as to whether there are more parts in the first system to assign to a group (decision 340). If there are more parts to assign to a group, decision 340 branches to the “Yes” branch, which loops back to select and group the next part. This looping continues until there are no more parts to group, at which point decision 340 branches to the “No” branch.

At step 350, processing selects the first part group (e.g., processors) and, at step 360, creates part categories according to the part information stored in the selected part group. For example, processing may identify a premium version processor and a base version processor within a processor part group and, as such, create a premium category and a base category accordingly. As those skilled in the art can appreciate, other approaches may be utilized to create categories within a group, such as using pre-defined categories.

Processing assigns each of the parts within the selected group to their corresponding category at step 370, and a determination is made as to whether there are more part groups for which to create categories and assign parts to the categories (decision 380). If there are more part groups, decision 380 branches to the “Yes” branch, which loops back to select and process the next part group. This looping continues until there are no more part groups for which to create categories, at which point decision 380 branches to the “No” branch, whereupon processing returns at 390.

FIG. 4 is a flowchart showing steps taken in mapping parts utilized in a second system to parts utilized in a first system. Processing commences at 400, whereupon processing selects a part included in a second system at step 410 (referred to herein as a second part). In one embodiment, processing retrieves product information from second system data store 215 such as a part number, performance information, etc.

Next, at step 420, processing identifies a part group that corresponds to the selected part (e.g., processor part group, memory part group, etc.), and stores part information of the selected part (e.g., part number) in the identified part group located in forecast store 280. A determination is made as to whether there are more parts from the second system to assign to a part group (decision 440). If there are more parts to assign to a part group, decision 440 branches to the “Yes” branch, which loops back to select and process a different part. This looping continues until there are no more parts to assign to a part group, at which point decision 440 branches to the “No” branch.

At step 450, processing selects a part group in forecast store 280 and, at step 460, processing assigns each of the second system parts to a particular category within the part group (e.g., premium category, base category, etc.). In one embodiment, processing assigns categories based upon their part number. In another embodiment, processing assigns a category to a part based upon the parts performance relative to other parts assigned to the same category.

Processing, at step 470, maps the second system parts to the first system parts according to their group and category. For example, a first system's 2 GB memory device may be mapped to a second system's 8 GB memory device because they were both assigned into a “base” category within a memory group (see FIG. 8 and corresponding text for further details).

A determination is made as to whether there are more part groups that include parts for which to map (decision 480). If there are more part groups for which to map parts, decision 480 branches to the “Yes” branch, whereupon processing loops back to select a different part group. This looping continues until there are no part groups for which to map parts, at which point decision 480 branches to the “No” branch, whereupon processing returns at 490.

FIG. 5 is a flowchart showing steps taken in generating a functioning parts returns forecast and a new parts order plan for a second system's production lifecycle. Processing commences at 500, whereupon, at step 510, processing computes a system forecast ratio based upon production quantities of a correlated first system (from FIG. 2) and forecast quantities of the second system. For example, a business may have shipped 1,000 first systems and plans to ship 2,000 second systems. In this example, the system forecast ratio would be 1:2.

At step 520, processing retrieves first system functioning parts returns data from first system data store 235, such as the amount and type of processor/memory returns that still function (e.g., returned for upgrades, etc.). Next, processing computes a second system functioning parts returns quantity based upon the first system parts returns data and the system forecast ratio. For example, assuming that 500 first system premium processors were returned and a 1:2 system ratio, processing computes 500×2=1,000 second system premium processor returns.

A determination is made as to whether functioning parts have been returned for the second system (decision 540). For example, the second system may have started shipments and a manufacturer may be receiving upgrade returns from customers. If functioning parts have been returned, decision 540 branches to the “Yes” branch, whereupon processing computes a second system parts returns start time based upon the actual returns data (step 550). In one embodiment, a manufacturer may sporadically receive functioning parts returns. In this embodiment, processing may compute the second system parts returns start time based upon a time at which the functioning parts are returned at a consistent rate (as opposed to the time at which the first functioning part was returned).

On the other hand, if functioning parts have not been returned for the second system, decision 540 branches to the “No” branch, whereupon processing computes a first parts returns lag time based upon a first parts returns start time relative to the first system's production start time (step 555). For example, assuming the first system production start time was May 2010 and the first parts returns start time was August 2010, the first parts returns lag time is three months.

Processing, at step 560, computes a second parts returns start time based upon the second system production start time and the first parts returns lag time (see FIG. 6 and corresponding text for further details). Using the example above and assuming that the second system production start time is June 2011, the second parts returns start time will be September 2011 (three months lag time).

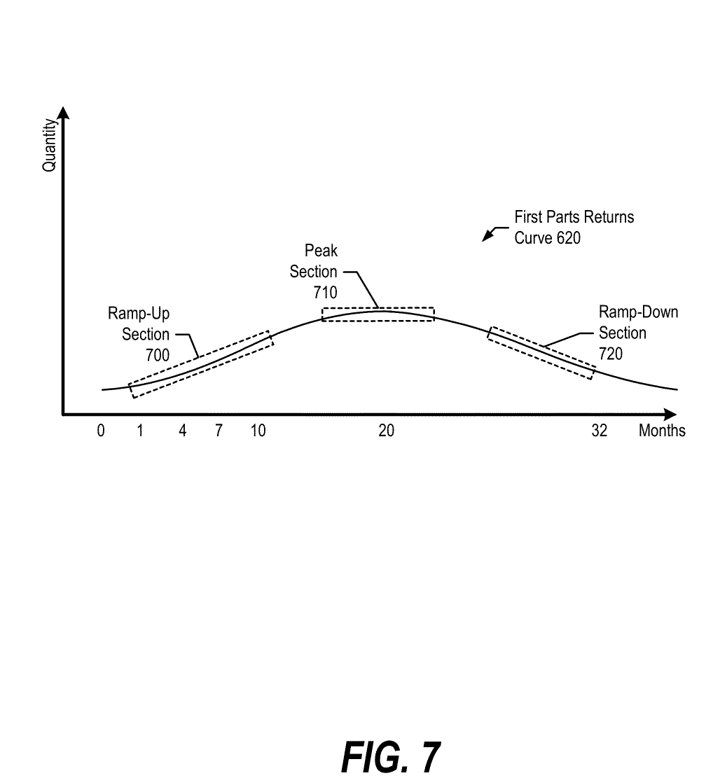

Processing analyzes a first parts returns curve (trend lines) and generates a comparable second parts returns curve at step 565. The first parts returns curve plots trends of first system parts returns over time, and the second parts returns curve plots a forecast amount of second system parts returns over time (see FIG. 6 and corresponding text for further details). In one embodiment, processing performs statistical analysis of the first parts returns curve to analyze trend lines, such as a uniform analysis, a linear regression analysis, or an autoregressive integrated moving average analysis (see FIG. 7 and corresponding text for further details).

Processing, at step 570, generates a functioning second parts returns forecast based upon the computed second parts returns start time, the second parts returns curve, and the computed second system parts returns quantity. The second functioning second parts returns forecast is stored in forecast store 280.

In turn, processing generates a second system new parts order plan for the second system's parts based upon the overall second system's parts requirements less the functioning second parts returns forecast (step 580). Processing returns at 590.

FIG. 6 is a diagram showing two system production curves and two corresponding functioning parts returns curves. Graph 600 shows first system production curve 610, which plots first system production quantities over time. First parts returns curve 620 plots functioning parts returns from the first system over time. Graph 600 also shows first parts returns lag time 630, which is the amount of time between the first system's start of production and the first parts returns start time.

Second system production forecast curve 640 plots the second system production forecast over time. Second parts returns curve 650, in one embodiment, is generated based upon the shape of first parts returns curve 620 (see FIG. 7 and corresponding text for further details). In another embodiment, second parts returns curve 650 has a lagging starting point (second parts returns lag time 660) based upon first parts returns lag time 630.

FIG. 7 is a diagram showing a first parts return curve segmented and analyzed in three sections. First parts returns curve 620 may be segmented into three sections, each representing a well-defined stage of a parts returns life cycle. Each section is then analyzed and forming a line equation of the curve within the section. In turn, the line equations may be utilized as a basis for computing a second parts returns curve.

In one embodiment, processing may use analysis techniques such as a uniform analysis, linear regression analysis, non-linear forecasting, and/or an ARIMA (autoregressive integrated moving average) analysis to analyze the first system parts returns. A uniform analysis involves drawing straight lines that best represent the actual data. A linear regression analysis involves drawing multiple segments of straight lines to represent peaks and valleys in each segment to best represent the actual returns data (see FIG. 5 and corresponding text for further details). And the ARIMA approach involves sophisticated statistical techniques to curve-fit the two curves.

In a system life cycle, ramp up section 700 includes the beginning stages of receiving functioning part returns and typically spans from months 1-10 after system production launch. Returns peak 510 includes a mid-point stage of receiving functioning parts returns and typically spans months 15-24 after system production launch. And, ramp down 520 includes an ending stage of receiving functioning parts returns and typically spans months 25-32 after production launch.

FIG. 8 is a diagram showing first system parts mapped to second system parts according to a part group and part category. Table 800 includes table entries that map first system parts (column 830) to second system parts (column 840) based upon part groups (column 810) and part categories (column 820). As those skilled in the art can appreciate, other approaches may be utilized to map first system parts to second system parts (e.g., arrays, etc.).

In one embodiment, parts are placed in particular part categories based upon part relevance. For example, column 830 shows that a 16 GB memory device is in the premium category, whereas column 840 shows that the 16 GB memory device is in the mid-level category. This is because the second system utilizes a 32 GB memory device. As such, the second system's 16 GB memory device is a mid-level product relative to the 32 GB memory device.

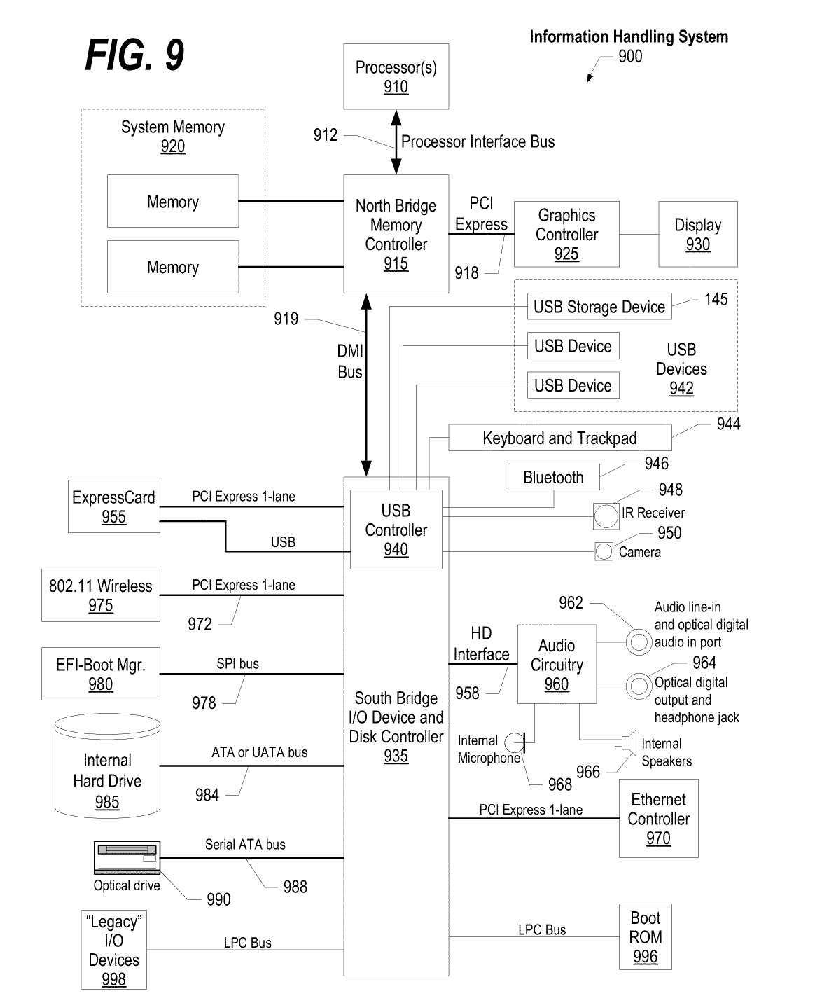

FIG. 9 illustrates information handling system 900, which is a simplified example of a computer system capable of performing the computing operations described herein. Information handling system 900 includes one or more processors 910 coupled to processor interface bus 912. Processor interface bus 912 connects processors 910 to Northbridge 915, which is also known as the Memory Controller Hub (MCH). Northbridge 915 connects to system memory 920 and provides a means for processor(s) 910 to access the system memory. Graphics controller 925 also connects to Northbridge 915. In one embodiment, PCI Express bus 918 connects Northbridge 915 to graphics controller 925. Graphics controller 925 connects to display device 930, such as a computer monitor.

Northbridge 915 and Southbridge 935 connect to each other using bus 919. In one embodiment, the bus is a Direct Media Interface (DMI) bus that transfers data at high speeds in each direction between Northbridge 915 and Southbridge 935. In another embodiment, a Peripheral Component Interconnect (PCI) bus connects the Northbridge and the Southbridge. Southbridge 935, also known as the I/O Controller Hub (ICH) is a chip that generally implements capabilities that operate at slower speeds than the capabilities provided by the Northbridge. Southbridge 935 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 996 and “legacy” I/O devices (using a “super I/O” chip). The “legacy” I/O devices (998) can include, for example, serial and parallel ports, keyboard, mouse, and/or a floppy disk controller. The LPC bus also connects Southbridge 935 to Trusted Platform Module (TPM) 995. Other components often included in Southbridge 935 include a Direct Memory Access (DMA) controller, a Programmable Interrupt Controller (PIC), and a storage device controller, which connects Southbridge 935 to nonvolatile storage device 985, such as a hard disk drive, using bus 984.

ExpressCard 955 is a slot that connects hot-pluggable devices to the information handling system. ExpressCard 955 supports both PCI Express and USB connectivity as it connects to Southbridge 935 using both the Universal Serial Bus (USB) the PCI Express bus. Southbridge 935 includes USB Controller 940 that provides USB connectivity to devices that connect to the USB. These devices include webcam (camera) 950, infrared (IR) receiver 948, keyboard and trackpad 944, and Bluetooth device 946, which provides for wireless personal area networks (PANs). USB Controller 940 also provides USB connectivity to other miscellaneous USB connected devices 942, such as a mouse, removable nonvolatile storage device 945, modems, network cards, ISDN connectors, fax, printers, USB hubs, and many other types of USB connected devices. While removable nonvolatile storage device 945 is shown as a USB-connected device, removable nonvolatile storage device 945 could be connected using a different interface, such as a Firewire interface, etcetera.

Wireless Local Area Network (LAN) device 975 connects to Southbridge 935 via the PCI or PCI Express bus 972. LAN device 975 typically implements one of the IEEE 802.11 standards of over-the-air modulation techniques that all use the same protocol to wireless communicate between information handling system 900 and another computer system or device. Optical storage device 990 connects to Southbridge 935 using Serial ATA (SATA) bus 988. Serial ATA adapters and devices communicate over a high-speed serial link. The Serial ATA bus also connects Southbridge 935 to other forms of storage devices, such as hard disk drives. Audio circuitry 960, such as a sound card, connects to Southbridge 935 via bus 958. Audio circuitry 960 also provides functionality such as audio line-in and optical digital audio in port 962, optical digital output and headphone jack 964, internal speakers 966, and internal microphone 968. Ethernet controller 970 connects to Southbridge 935 using a bus, such as the PCI or PCI Express bus. Ethernet controller 970 connects information handling system 900 to a computer network, such as a Local Area Network (LAN), the Internet, and other public and private computer networks.

While FIG. 9 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

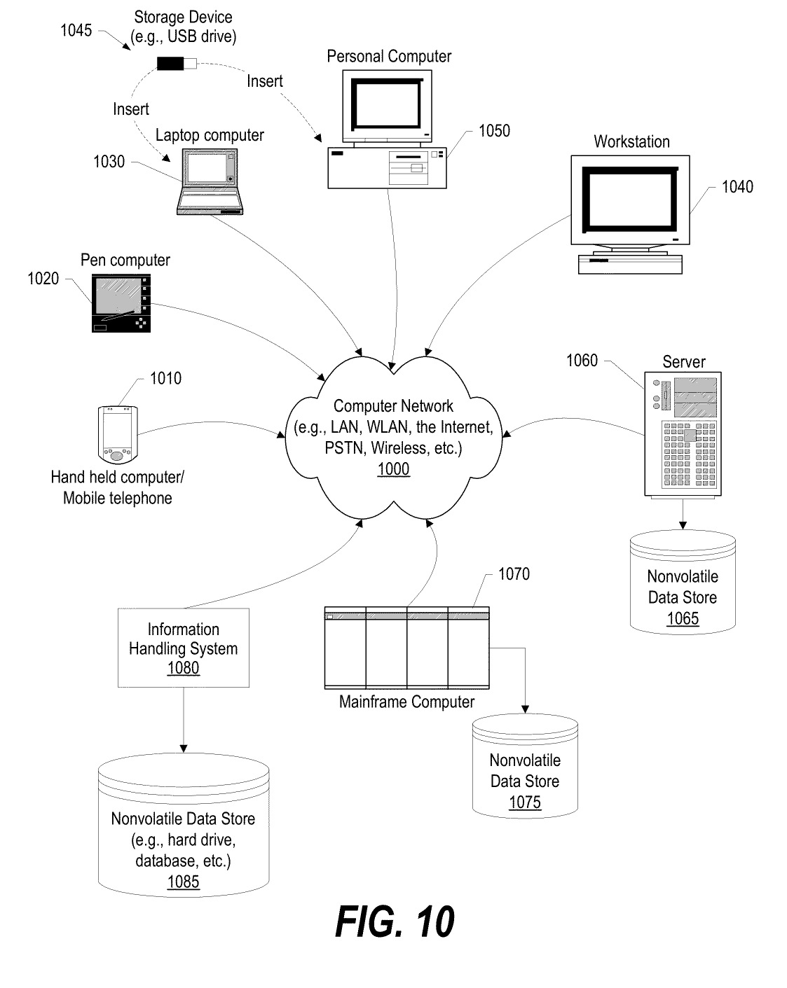

FIG. 10 provides an extension of the information handling system environment shown in FIG. 9 to illustrate that the methods described herein can be performed on a wide variety of information handling systems that operate in a networked environment. Types of information handling systems range from small handheld devices, such as handheld computer/mobile telephone 1010 to large mainframe systems, such as mainframe computer 1070. Examples of handheld computer 1010 include personal digital assistants (PDAs), personal entertainment devices, such as MP3 players, portable televisions, and compact disc players. Other examples of information handling systems include pen, or tablet, computer 1020, laptop, or notebook, computer 1030, workstation 1040, personal computer system 1050, and server 1060. Other types of information handling systems that are not individually shown in FIG. 10 are represented by information handling system 1080. As shown, the various information handling systems can be networked together using computer network 1000. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 10 depicts separate nonvolatile data stores (server 1060 utilizes nonvolatile data store 1065, mainframe computer 1070 utilizes nonvolatile data store 1075, and information handling system 1080 utilizes nonvolatile data store 1085). The nonvolatile data store can be a component that is external to the various information handling systems or can be internal to one of the information handling systems. In addition, removable nonvolatile storage device 945 can be shared among two or more information handling systems using various techniques, such as connecting the removable nonvolatile storage device 945 to a USB port or other connector of the information handling systems.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. (canceled)

2. (canceled)

3. (canceled)

4. (canceled)

5. (canceled)

6. (canceled)

7. (canceled)

8. (canceled)

9. (canceled)

10. An information handling system comprising:
one or more processors;
a memory coupled to at least one of the processors;
a set of computer program instructions stored in the memory and executed by at least one of the processors in order to perform actions of:
mapping, by one or more of the processors, one or more first parts included in a first system to one or more second parts included in a second system;
retrieving from the memory, by one or more of the processors, functioning first parts returns data that indicates an amount of one or more of the first parts that have been returned and are functioning;
forecasting, by one or more of the processors, an amount of one or more of the second parts to be returned and functioning based upon the functioning first parts returns data and the mapping of one or more of the first parts to one or more of the second parts; and
generating a functioning second parts returns forecast based upon the forecasted amount of one or more of the second parts.

11. The information handling system of claim 10 wherein the set of instructions, when executed by one or more of the processors, further perform actions of:
computing a first parts returns lag time based upon a first system production start time and a first parts returns start time;
determining whether one or more of the second parts have been returned; and
in response to determining that one or more of the second parts have not been returned, computing a second parts returns start time based upon the first parts returns lag time and a second system production start time corresponding to the second system.

12. The information handling system of claim 11 wherein the set of instructions, when executed by one or more of the processors, further perform actions of:
in response to determining that one or more of the second parts have been returned, computing the second parts returns start time based upon an actual time that one or more of the second parts have been returned.

13. The information handling system of claim 12 wherein the set of instructions, when executed by one or more of the processors, further perform actions of:
generating a first parts returns curve based upon the functioning first parts returns data, wherein the first parts returns curve graphs the amount of one or more of the first parts that have been returned over time; and
generating a second parts returns forecast curve based upon the first parts returns curve, the second parts returns start time, and the forecasted amount of one or more of the second parts, wherein the functioning second parts returns forecast is based upon the second parts returns forecast curve.

14. The information handling system of claim 13 wherein, prior to generating the second parts returns forecast curve, the set of instructions, when executed by one or more of the processors, further perform actions of:
analyzing the first parts returns curve, wherein the analyzing is selected from the group consisting of a uniform analysis, a linear regression analysis, and an autoregressive integrated moving average analysis; and
wherein the generation of the second parts returns forecast curve is based upon the analyzing of the first parts returns curve.

15. The information handling system of claim 10 wherein the set of instructions, when executed by one or more of the processors, further perform actions of:
retrieving a second system production forecast that indicates a production rate of the second system type; and
generating a second system new parts order plan based upon the second system production forecast and the functioning second parts returns forecast.

16. The information handling system of claim 10 wherein the set of instructions, when executed by one or more of the processors, further perform actions of:
selecting one of the second parts;
identifying a part group that corresponds to the selected second part;
identifying a part category, within the identified part group, that corresponds to the selected second part;
identifying a first part that is included in the identified part category within the identified part group; and
mapping the selected second part to the identified first part.

17. The information handling system of claim 10 wherein, prior to the mapping, the set of instructions, when executed by one or more of the processors, further perform actions of:
retrieving first system type quantity data and first system type timing data;
retrieving second system type forecast quantity data and second system type forecast timing data;
comparing the first system type quantity data to the second system type forecast quantity data;
analyzing the first system type timing data against the second system type forecast timing data; and
determining that the first system type correlates to the second system type in response to the comparing and the analyzing.

18. The information handling system of claim 17 wherein the set of instructions, when executed by one or more of the processors, further perform actions of:
computing a system forecast ratio based upon the first system type quantity data and the second system type forecast quantity data; and
utilizing the system forecast ratio during the forecasting of the amount of functioning second parts.

19. A computer program product stored in a computer readable storage medium, comprising computer program code that, when executed by an information handling system, causes the information handling system to perform actions comprising:
mapping, by one or more processors, one or more first parts included in a first system to one or more second parts included in a second system;
retrieving, by one or more of the processors, functioning first parts returns data that indicates an amount of one or more of the first parts that have been returned and are functioning;
forecasting, by one or more of the processors, an amount of one or more of the second parts to be returned and functioning based upon the functioning first parts returns data and the mapping of one or more of the first parts to one or more of the second parts; and
generating a functioning second parts returns forecast based upon the forecasted amount of one or more of the second parts.

20. The computer program product of claim 19 wherein the information handling system performs further actions comprising:
computing a first parts returns lag time based upon a first system production start time and a first parts returns start time;
determining whether one or more of the second parts have been returned;
in response to determining that one or more of the second parts have not been returned, computing a second parts returns start time based upon the first parts returns lag time and a second system production start time corresponding to the second system; and
in response to determining that one or more of the second parts have been returned, computing the second parts returns start time based upon an actual time that one or more of the second parts have been returned.

21. The computer program product of claim 20 wherein the information handling system performs further actions comprising:
generating a first parts returns curve based upon the functioning first parts returns data, wherein the first parts returns curve graphs the amount of one or more of the first parts that have been returned over time; and
analyzing the first parts returns curve, wherein the analyzing is selected from the group consisting of a uniform analysis, a linear regression analysis, and an autoregressive integrated moving average analysis; and
generating a second parts returns forecast curve based upon the analysis of the first parts returns curve, the second parts returns start time, and the forecasted amount of one or more of the second parts, wherein the functioning second parts returns forecast is based upon the second parts returns forecast curve.

22. The computer program product of claim 19 wherein the information handling system performs further actions comprising:
selecting one of the second parts;
identifying a part group that corresponds to the selected second part;
identifying a part category, within the identified part group, that corresponds to the selected second part;
identifying a first part that is included in the identified part category within the identified part group; and
mapping the selected second part to the identified first part.

23. The computer program product of claim 19 wherein the information handling system performs further actions comprising:
retrieving first system type quantity data and first system type timing data;
retrieving second system type forecast quantity data and second system type forecast timing data;
comparing the first system type quantity data to the second system type forecast quantity data;
analyzing the first system type timing data against the second system type forecast timing data; and
determining that the first system type correlates to the second system type in response to the comparing and the analyzing.

24. (canceled)

25. An information handling system comprising:
one or more processors;
a memory coupled to at least one of the processors;
a set of computer program instructions stored in the memory and executed by at least one of the processors in order to perform actions of:
mapping, by one or more of the processors, one or more first parts included in a first system to one or more second parts included in a second system;
retrieving, by one or more of the processors, functioning first parts returns data that indicates an amount of one or more of the first parts that have been returned and are functioning;
forecasting, by one or more of the processors, an amount of one or more of the second parts to be returned and functioning based upon the functioning first parts returns data and the mapping of one or more of the first parts to one or more of the second parts;
computing, by one or more of the processors, a first parts returns lag time based upon a first system production start time and a first parts returns start time;
determining, by one or more of the processors, whether one or more of the second parts have been returned;
in response to determining that one or more of the second parts have not been returned, computing a second parts returns start time based upon the first parts returns lag time and a second system production start time corresponding to the second system;
in response to determining that one or more of the second parts have been returned, computing the second parts returns start time based upon an actual time that one or more of the second parts have been returned;
generating, by one or more of the processors, a first parts returns curve based upon the functioning first parts returns data, wherein the first parts returns curve graphs the amount of one or more of the first parts that have been returned over time;
generating, by one or more of the processors, a second parts returns forecast curve based upon the first parts returns curve, the second parts returns start time, and the forecasted amount of one or more of the second parts; and
generating, by one or more of the processors, a functioning second parts returns forecast based upon the generated second parts returns forecast curve.
